(19) United States
(12) Patent Application Publication
(10) Pub. No.: US 2008/0191857 A1
(43) Pub. Date: Aug. 14, 2008

(54) ARMED System for Fire and Intrusion Protection using Landline Phone or VoIP or Cellular Telephone Networks

(76) Inventor: Michael Mansour Mojaver, Pasadena, CA (US)

Correspondence Address: Michael M. Mojaver, 1105 Pine Bluff Drive, Pasadena, CA, 91107-1753, US

(21) Appl. No.: 11/674,067

(22) Filed: Feb. 12, 2007

(51) Int. Cl. G08B 21/00

(52) U.S. Cl. 340/500

(57) ABSTRACT

An Electronic/Communication system here forth interchangeably referred to as “ARMED” or “ARMED System” enabling households including single family residence owners or renters, condominium owners or renters and apartment renters as well as commercial, industrial offices and retail business operators to personally purchase from retail outlets, install and easily operate the system. When in operation, the ARMED System will inform the homeowner/renter or business owner/operator as well as local law enforcement including police department and fire department if and when there is intrusion, holdup or fire at the premises.

### SUMMARY

ARMED System is a protection/security alarm system that can be activated directly and locally from its Central Control Console (CCC) or remotely via dialing in to the ARMED System. It can also be deactivated either directly from its CCC keyboard or from remote location via dialing in to the system using any corded, cordless or wireless telephone device. The remote capability is particularly important as it will eliminate the problem associated with forgetting to activate before one leaves his/her residence or business. One can also call the system when in doubt about its activation status and verify remotely. Further, remote activation will eliminate the threshold time otherwise needed for one to walk to the current alarms closet, enter password, activate, lockup and leave or when coming back; to unlock and open the door, walk to the alarm closet, enter password and deactivate the alarm. Ability of the ARMED System to activate the siren immediately is of utmost importance as it empowers the system to instantaneously implement the first line of crime deterrence. The intruders are highly unlikely and almost impossible to ignore the ear piercing sound of siren and continue with their crime. Homeowner(s) and/or business owners approaching their ARMED equipped premises may call the ARMED System to verify the activation status and deactivate before entering. While at home and overnight, the sound of the siren is strong enough to scare and deter intruders and awake the home owners who can then proceed accordingly with either calling the police or stopping the siren and the ARMED System program after the criminals have run away. While in a remote vacation location, the homeowners may setup the ARMED System to send them an encapsulated text message and pre recorded voice message. The mere appearance of the caller ID is indicative to the owners that their property has been invaded. In such situation the property owner, renter, and/or lessee may choose to intercept the ARMED System program sequential execution with deactivation and proceed to call a trusted neighbor, friend and/or business associate and have them check upon the situation and/or call the local police on their behalf. They may also call the police directly themselves if they choose to do so. The ARMED System is also programmed to execute all alerts and escalations in a pre-determined order with canned text and voice messages. If and when in a part of the world where one may not have cellular coverage, they can easily have the ARMED System bypass calling them and proceed with the calls to the subsequent numbers as already programmed and send a text and voice messages to the predetermined recipients. The current invention in many ways as numerated further on this Patent Application defuses the shortcomings of the current alarms commercially available through Third Party Intermediaries (TPI) in protection/security alarm system domain. The fire protection mechanism is always ON regardless of the mode of operation. The fire protection algorithm combines the smoke detector and heat sensor to ensure that no false alarm is send due to smoke from regular cooking or from fireplace.

### BRIEF DESCRIPTION OF DRAWINGS

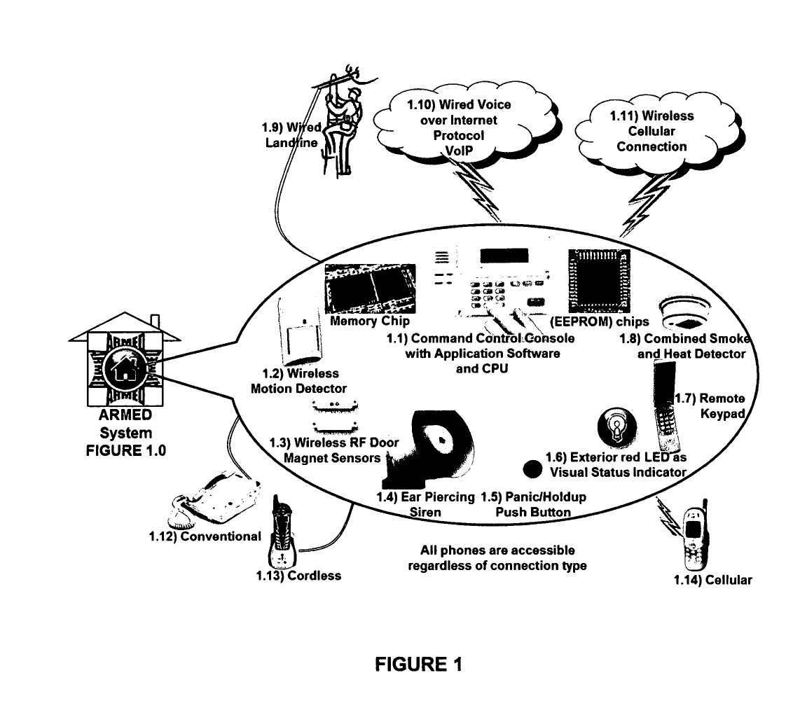

FIG. 1—The modular design of the current invention at the high level major components of design
1.0 ARMED System identifier and logo
1.1 Command Control Console (CCC) including;
   1.1.1. Central Processing Unit (Not Shown in picture)
   1.1.2. Memory Chips/Banks for user configuration of voice and text messages (Shown in picture)
   1.1.3. EEPROM to hold application software (Shown in picture)
   1.1.4. Application Software (Not Shown in picture)
   1.1.5. Conventional Phone Engine for Claims number one and number two of this invention (Not Shown in picture)
   1.1.6. Cellular Phone Engine for Claim number three of this invention (Not Shown in picture)
1.2 Radio Frequency (Wireless) Motion Detectors
1.3 Radio Frequency (Wireless) Magnetic Doorjamb Sensors
1.4 ARMED System Siren
1.5 Panic/Holdup Push Button
   1.5.1. Childproof for residences (Not Shown in Picture)
   1.5.2. Regular for businesses (Shown in picture)
1.6 Activation/Deactivation status indicator using red exterior mountable LED
1.7 Remote Keypad for Activation/Deactivation once left and locked up in lieu of using phone lines (Wired or Wireless) to remotely access
1.8 Combined RF Smoke and Heat Detector that eliminates False Alarm due to excessive smoke from cooking or starting fir in the fireplace
1.9 ARMED System using conventional Wired Landline
1.10 ARMED System using Voice over Internet Protocol via use of Data Landlines and DSL Modem or Cable Operators and Internet Cable Modem
1.11 ARMED System using Cellular Phone Infrastructure for connectivity
1.12 ARMED System ability to place call to and receive calls from Conventional Corded Phones
1.13 ARMED System ability to place call to and receive calls from Conventional Cordless Phones
1.14 ARMED System ability to place call to and receive calls from Wireless Cellular Phones

### BACKGROUND AND BRIEF DESCRIPTION OF THE INVENTION

The present invention relates to property owners, renters, and/or lessees' ability to protect their family and workers, their residence or business, and their assets and belongings incase of fire, intrusion, imminent intrusion, or holdup when at the premises and/or when away.

### BACKGROUND

1) Currently and historically the commercially available alarms are based on Landline and incapable of connecting to their Third Party Intermediary (TPI) centers via Voice over Internet Protocol (VoIP) and/or wirelessly (Cellular Network) communication lines.
2) The TPI's of the current alarms are often in one state covering the entire nation and as such not familiar with the inner workings of local police, paramedics, and fire departments in over 90% of areas they serve.
3) As opposed to the current invention, the existing alarms do not provide for remote setting of the alarm system. Therefore, if one forgets to set the alarm before one leaves, the only remedy is to go back to the premises and set the alarm. Imagine leaving with the entire family to vacation overseas and while in hurry one forgets to set the alarm. The entire vacation is ruined feeling worried all through the trip.
4) As opposed to the current invention, the existing alarms have a threshold of at least 45 seconds to set the alarm, exit the premises and lockup the doors. The same amount of time is provided when one returns to the premises so that one may unlock, walk to the alarm panel, enter the alarm password and disengage the alarm.
5) Further, if and when there is intrusion the same thresholds are applied and only when password is not entered and the alarm is not disengaged during the allotted time delay that the system recognizes that there is an intrusion. At this point which is minimum of 45 seconds since the time that intruders have started their activity the following sequence of events are triggered;
   a. System starts the siren. Due to the imposed delay, the criminal(s) are already inside the premises and they will hide inside. They may proceed with their crime when they feel that the siren is being ignored.
   b. Current alarms will then dial the TPI after the elapse of threshold time,
   c. If the Landlines are not inoperative either intentionally by the intruding criminals or inadvertently due to other causes, the TPI will be warned and notified.
   d. At this point an error prone TPI worker will get involved. Depending on the person's availability, attentiveness, and conscientious efforts he/she will call the property owner at the place where the alarm became activated.
   e. First the TPI worker will ask the panic stroked property owner to self identify and provide the password.
   f. The call from the TPI worker is to confirm intrusion and requires that the property owner be calm and remembers the password and report to them as to what is going on so that intermediary employee may proceed and call the police on their behalf.
      i. If the property owner is at the premises and not panic stroked, the chances are that he/she has already called their local police department, fire department or 911 during this crucial early stage of intrusion or fire. Further, the call from the TPI is more of a hindrance than a help at this point since the property owner is getting an unwanted call-waiting buzz when they have no time to answer it.
      ii. On the other hand if out of fear for their life, they are hiding in panic, there is no way that they will give up their cover and receive the call. After countless number of rings and leaving a voice message on the phone recording system (if one available), the TPI will proceed to call the alternative number in file.
      iii. The alternative number is either one of the; 1) property owners' cell phone(s) (husband, wife, or an adult child) or 2) a close relative, neighbor, or business colleague not at the location. If the alternative number belongs to one of the property owners who are at the location either the scenario i or the scenario ii above applies.
      iv. If on the other hand, the alternative number belongs to one of the members of the household or the property who is not at the location at the time or a close relative, friend, or business colleague who is not in walking distance from the premises, this may cause a total panic and can be led to further troubles due to traffic accident once the receiver of the call rushes to the location of the alarm. Also, at this point the call is irrational and unnecessary as no one from a remote location will ever advise the TPI to do any thing but to proceed and call the police department and/or the fire department.
      v. Also, if the entire family is away on vacation where there is no cellular coverage, or for any other reason the primary and secondary numbers cannot be reached, there will be another voice mail left before the police are contacted.
6) By this elongated elapsed time, the fire has got out of control or intruders have committed their crime, injured or murdered innocent people (if homeowners have not personally fended them off and call the police), broken to the safe and rubbed and vandalized the place and left. Criminals know the consequences of being caught so they are in and out in a flash.
7) This gives rise to the question—what is the value of the existing alarm systems?

### BRIEF DESCRIPTION OF THE CURRENT INVENTION

The present invention the ALARMED System addresses all the aforementioned flaws of current alarms as it rides on;
1) Ability to dial up and communicate on Landline and/or Voice over Internet Protocol (VoIP),
2) Ability to dial up on cellular network and communicate via voice or text message wirelessly therewith eliminate the risk of intruders cutting phone line before attempting to enter the premises,
3) Ability to broadcast pre-stored voice message(s) and text message(s),
4) Ability to send voice message(s) and/or text message(s) to several phone numbers as primary, secondary, tertiary, etc. numbers and ending with a call to the local police department and/or fire department as the case may be,
5) Ability to program the system for after-hour voice message(s) and/or text message(s) to be sent to local police department directly,
6) An always ON combined smoke and heat sensor ensures a timely alert and escalation of fire without false alarm due to regular cooking smoke and/or excessive smoke at startup of wood-burning fireplace,
7) Supports unlimited number of secured stations such as doors and windows,
8) Ability to detect motion in hallways and basements if and when intrusion was done avoiding the secured points of access,
9) Provides for remote activation and deactivation therewith eliminate the time threshold otherwise needed to enter password, activate, lockup, and leave or unlock door, enter premises, key-in password and deactivate.
10) The ability to call in using any type of phone to; enter password, check activation/deactivation status and set the ARMED System accordingly. This enables the authorized member(s) of the property approaching the entry door, to call via their cell phone and in case the building is ARMED, they will deactivate before entry.
11) The remote call-in ability is further complimented with a wireless keypad mounted outside at a location only be known to the authorized individuals. This keypad can also be used for activation/deactivation of the ARMED System from outside.
12) Lack of time delay and activation of ear piercing siren enables the first order of deterring criminals and preventing them from entering the premises.
13) The bright exterior mount LED will inform the property owners that the building is ARMED and will prevent unwanted and/or false alarm.
14) The system is equipped with audit trail indicating the date, times, and the persons who activated or deactivated the ARMED System.

Current alarms are inadequate, unreliable, slow in response, slow in activating the siren as the first line of deterrence, can be easily tampered with as the phone line can be cut before entry, and above all reliant on TPI's workers and as such extremely error prone.

### DETAILED DESCRIPTION OF INVENTION

The present invention of ARMED System consists of eight major components as described below;
1. The Central Control Console (CCC) that eliminates need for the Third Party Intermediaries (TPI's) comes in two major varieties;
   a. Wired for Landline and VoIP through conventional Phone-Line and DSL Modem or Cable connection and Cable Modem. This configuration of ARMED System contains a conventional Phone Engine, and
   b. Wireless with use of Cellular Network Technology. This configuration of ARMED System contains a Cellular Phone Engine.
In either case above the CCC consists of;
   i. Alpha numeric micro keyboard for programming, entering text messages, and dialing.
   ii. LED indicators to show if the property is ARMED.
   iii. Memory chips capable of holding;
      A. factory default S.O.S. Voice Message (VM),
      B. custom emergency Voice Message (VM),
      C. factory default S.O.S. Text Message (TM),
      D. custom emergency Text Message (TM), and
      E. audit trail of last N number of activations and deactivations with time and date stamp and the password of person activating and/or deactivating.
   iv. Embedded software that provides for remote (call-in) access with password security.
   v. Software also distinguishes and provides for the security while locked up during working hours (or stay at home overnight lockup) with deactivating the motion detector. It also distinguishes and provides for the security while locked up during away hours (after work hours for businesses and during away from home for residences).
2. Radio Frequency Motion Detectors report to the CCC wirelessly if and when a motion is detected in the “Away” mode of operation for after work hours for businesses and during “Away” mode of operation for residences. Several motion detectors may be mounted where intruders can avoid direct entry through secured access doors. These locations may include but are not limited to hallways, stair wells, basements, etc.
3. Wireless Magnet Doorjamb sensors that can be mounted on conventional doors, sliding doors and variety of windows. These sensors have a bright red LED that is visible even during the day light to indicate if and when the property is ARMED.
4. Siren that would be placed in an inconspicuous location will be activated instantaneously as the first line of deterrence. Upon unwanted entry, any of the motion detectors or doorjamb sensors in the system that have been violated by the intruders will send a wireless signal to the CCC. The CCC will instantaneously activate the Siren.
5. The wireless and childproof “Panic” push button for residences or “Holdup” push button for commercial/business use.
6. Exterior mount bright LED indicator of the ARMED System activation status that eliminates false alarm.
7. An always “ON” combined wireless Smoke and Heat Detector for No False warning of Fire.

### MODES OF OPERATION

Fire Larm

Regardless of the intrusion mode of operation elaborated below and consisting of, AWAY Mode for Residences or Businesses and STAY Mode for Residences or Businesses, the Fire Alarm is always ARMED. A Signal from a wireless “No False Alarm” combined Smoke and Heat detector to CCC will activate a call and send a Voice Message and Text Message to the Local Fire Department as well as all other phone numbers in the ALARMED System program.
A typical 30 seconds voice message or text message for the always “ON” Fire Alarm is;
   i. EMERGENCY: FIRE at residence at 123 Main Street, Happy Sparrow, Calif., 91234—Mr. & Mrs. Owner may be reached at (321) 555-4321 & (321) 555-1234. This message will repeat total of four times. PLEASE TAKE A NOTE AND DISPATCH FIRE ENGINES AND PERSONNEL IMMEDIATELY.

AWAY: The ARMED System is activated in this mode when last person leaves the premises.

### 1. Residential Use:

This “AWAY” mode for residential use has two alternative paths.
a. Reachable: This mode is for daily routine leaving to work and school. The ARMED System is typically programmed with the head of household's phone number as primary, the second parent's phone number as secondary, a reserved phone number as tertiary (e.g., an adult child of the household), a trusted friend/relative phone number leaving close-by as the fourth recipient of a call, and finally the local police department number. The pre-stored voice message and text message will be sent to these phone numbers in sequence and after preset time elapse intervals until and unless the ARMED System is deactivated. Deactivation can be done local to the system from the CCC keyboard or remotely be any of the primary, secondary, tertiary, etc. call recipients via secured and password authenticated access. Deactivation of one sequence will not deactivate the call to the police station and/or the siren.

Unless the authorized user deactivates all remaining sequences and the siren, the ear piercing siren will continue until the police arrive. The siren however can only be deactivated at the system console or by a separate remote command by authorized members.
A typical 45 seconds voice message or text message for this residential reachable mode of AWAY operation is;
   ii. EMERGENCY: Intrusion, Vandalism, Rubbery, or Crime in progress at residence at 123 Main Street, Happy Sparrow, Calif., 91234—Mr. & Mrs. Owner may be reached at (321) 555-4321 & (321) 555-1234. This message will repeat total of four times. PLEASE TAKE A NOTE AND CALL HAPPY SPARROW POLICE AT (321) 555-2121
   iii. EMERGENCY: Intrusion in progress at 123 Main Street, Happy Sparrow, Calif., 91234—Owners may be reached at (321) 555-4321 & (321) 555-1234. This message will repeat total of four times. PLEASE TAKE A NOTE AND CALL HAPPY SPARROW POLICE AT (321) 555-2121
      To deactivate further escalation call the residence at (321) 555-2323 and use the PIN 223344.
      The voice message will become activated (broadcast) after the recipient phone goes off-hook. The message will repeat four times within 3 minutes giving the recipient opportunity to make note of address and phone number(s). The text message however is sent only once. If the recipient of the call is one of the household members, the mere caller ID of their residence when no one is expected to be home is an indication of intrusion therewith they may callback expeditiously to the CCC and stop the execution of the remaining sequence of events or expedite the call to the police.
b. Unreachable: This mode is for when the family is traveling on vacation and cannot be reached via cell phone or chooses not to be reached. The head of household's phone number as primary and the second parent's phone number as secondary as well as the tertiary phone number will be bypassed by the CCC and the trusted friend/relative leaving close-by will be contacted. After the voice message and text message are sent and the receiver of the call has terminated the call, a short pre allotted time delay will elapse before the local police department is contacted by the CCC. The call sequence to the police can be intercepted by the trusted friend/relative living close by if they realize that there is a false alarm within the allotted time. Deactivation can be done remotely be this the trusted friend/relative. Unless deactivated, the ear piercing siren will continue until the police arrive. Deactivating the call to the police will not stop the siren. The ear piercing siren can only be deactivated at the system console or by a separate remote command by authorized member.
A typical 45 seconds voice message or text message for this Residential Unreachable AWAY mode of operation is;
   i. EMERGENCY: Intrusion, Vandalism, Rubbery, or Crime in progress at residence at 123 Main Street, Happy Sparrow, Calif., 91234—Mr. & Mrs. Owner CAN NOT be reached. This message will repeat total of four times. PLEASE TAKE A NOTE AND CALL HAPPY SPARROW POLICE AT (321) 555-2121
   ii. EMERGENCY: Intrusion in progress at 123 Main Street, Happy Sparrow, Calif., 91234—Owners CAN NOT be reached. This message will repeat total of four times. PLEASE TAKE A NOTE AND CALL HAPPY SPARROW POLICE AT (321) 555-2121 To deactivate the further escalation call the ARMED System at (321) 555-2323 and use the PIN 223344.
      The voice message will become activated (broadcast) after the recipient phone goes off-hook. The message will repeat four times within 3 minutes giving the recipient opportunity to make note of address and phone number(s). The text message however is sent only once.

### 2. Commercial/Business Use:

This “AWAY” mode for commercial/business operation has two alternative paths.
a. During Hours: This mode may mostly be used by small businesses like retail jewelry stores when during the working hours the owner/manager needs to lockup for a short period and attend to some for instance routine banking activities. The ARMED System is typically programmed with maximum of four phone numbers of the authorized people who all have access and keys to enter the premises. A trusted next door business colleague may be the last one in this sequence before the police are contacted by the CCC of ARMED System. Until and unless the CCC is deactivated the ARMED software executes its program in a sequence and after expiration of each allotted short time elapse between calls. Deactivation can be done local to the system from the CCC keyboard or remotely be any of the call recipients. Unless deactivated, the ear piercing siren will continue until the police arrive. The siren however can only be deactivated at the system console or by separate remote command by authorized members.
A typical 45 seconds voice message or text message for this “Commercial/Business—AWAY—During Hours” mode of operation is;
   i. EMERGENCY: Intrusion, Vandalism, Rubbery, or Crime in progress at business located at 123 Main Street, Happy Sparrow, Calif., 91234—Mr./Mrs. Business Owner may be reached at (321) 555-4321 & (321) 555-1234. This message will repeat total of four times. PLEASE TAKE A NOTE AND CALL HAPPY SPARROW POLICE AT (321) 555-2121
   ii. EMERGENCY: Intrusion in progress at 123 Main Street, Happy Sparrow, Calif., 91234—Owners may be reached at (321) 555-4321 & (321) 555-1234. This message will repeat total of four times. PLEASE TAKE A NOTE AND CALL HAPPY SPARROW POLICE AT (321) 555-2121
      To deactivate the further escalation call the ARMED System at (321) 555-2323 and use the PIN 223344.
      The voice message will become activated (broadcast) after the recipient phone goes off-hook. The message will repeat four times within 3 minutes giving the recipient opportunity to make note of address and phone number(s). The text message however is sent only once. If the recipient of the call is one of the business members, the mere caller ID of their business when no one is expected to be there is an indication of intrusion therewith they may expeditiously callback the ARMED System to stop the execution of the remaining sequence of events wherewith expedite the call to the police.
b. After Hours: This Commercial/Business “AWAY” mode is for when the business is closed at night or over weekend/holiday. In this mode all the calls will be suppressed and the business owner/manager may decide to be the first order of contact or directly have the system contact the police first and the business owner/manager second. After the voice message and text message are sent and the receiver of the call has terminated the call, a short pre allotted time elapse will occur before the secondary phone number (police or business owner/manager) is contacted by the ARMED System. The call sequence to the police can be intercepted by the owner/manager if within the allotted time it can be realized that there is a false alarm. Deactivation can be done remotely be the business owner/manager. Unless deactivated, the instantaneous ear piercing siren will continue until the police arrive. Deactivating the call to the police will not stop the siren. The siren, however, can be deactivated at the system console or by a separate remote command by the business owner/manager.
A typical 45 seconds voice message or text message for this “Commercial/Business—AWAY—After Hours” mode of operation is;
   EMERGENCY: Intrusion, Vandalism, Rubbery, or Crime in progress at business at 123 Main Street, Happy Sparrow, Calif., 91234—Mr. or Mrs. Business Owner (name) not at the location but may be reached at (321) 555-4321. This message will repeat total of four times. PLEASE TAKE A NOTE AND CALL HAPPY SPARROW POLICE AT (321) 555-2121
      The voice message will become activated (broadcast) after the recipient phone (police) goes off-hook. The message will repeat four times within 3 minutes giving the police opportunity to make note of address and phone number. The text message however is sent only once. The business owner/manager may callback the ARMED System to stop the execution of the remaining sequence of events, namely, the call to the police.
         STAY: The ARMED System is activated in this mode when authorized people are at the premises.

### 1. Residential Use:

This residential “STAY” mode has two alternative paths;
a. Intrusion: This Residential “Stay” Intrusion mode is typically used for overnight peace of mind. As the intrusion happens while the residents are at home the ARMED System will activate the siren and it will bypass the first four phone numbers reserved for the parents (2), an adult child (1), and the trusted friend/relative (1) in the sequence. After a short allotted elapsed time for disengaging the siren and ARMED System at the console in case of false alarm, the local police station will be contacted. The pre-stored voice message and text message will be sent to the police station. Unless deactivated, the ear piercing siren will continue until the police arrive.
A typical 45 seconds voice message or text message for this “Residential Stay Intrusion” mode of operation is;
   EMERGENCY: Intrusion, Vandalism, Rubbery, or Crime in progress at residence at 123 Main Street, Happy Sparrow, Calif., 91234—The residents are at the location at (321) 555-4321. AN EXPEDITIOUS POLICE INTERVENTION IS NEEDED. This message will repeat total of four times. PLEASE TAKE A NOTE OF ADDRESS AND PHONE NUMBER.
      The voice message will become activated (broadcast) after the police phone goes off-hook. The message will repeat four times within 3 minutes giving the police the opportunity to make note of address and phone number. The text message, however, is sent only once. The ear piercing siren can only be deactivated at the system console.
b. Panic Mode: The wireless and child proof panic push buttons are located in an easy to access and the most likely locations in the household where the approaching and/or likelihood of intrusion can be spotted. Pressing the wireless Panic Button(s) will bypass the otherwise short allotted time elapse and will instantly activate the siren and place a call directly to the local police department sending the voice message and text message. Unless deactivated, the ear piercing siren will continue until the police arrive and can only be deactivated at the system console.
A typical 45 seconds voice message or text message for the this “Residential Stay Panic” mode of operation is;
   EMERGENCY: Intruders are spotted entering the residence at 123 Main Street, Happy Sparrow, Calif., 91234—The residents are at the location at (321) 555-4321. AN EXPEDITIOUS POLICE INTERVENTION IS NEEDED. This message will repeat total of four times. PLEASE TAKE A NOTE OF ADDRESS AND PHONE NUMBER.
      The voice message will become activated (broadcast) after the police phone goes off-hook. The message will repeat four times within 3 minutes giving the police the opportunity to make note of address and phone number. The text message, however, is sent only once.

### 2. Commercial/Business Use:

The “Commercial/Business—STAY” mode has three alternative paths.
a. During Hours: This “Commercial/Business—STAY—During Hours” mode may mostly be used by small businesses such as restaurant operators and likes when during the working hours the doors are locked to the patrons while workers are attending to preparation operations. The ARMED System bypasses calling all authorized business people phone numbers including the trusted next door business colleague (the first four numbers out of five) as the ear piercing siren is enough to notify neighbors. Therefore, the police are contacted by the CCC of the ARMED System at once. Deactivation of the ARMED System and the siren can only be done local to the system from the CCC keyboard. Unless deactivated, the ear piercing siren will continue until the police arrive.
A typical 45 seconds voice message or text message for this “Commercial/Business—Stay—During Hours” mode is;
   EMERGENCY: Intrusion, Vandalism, Rubbery, or Crime in progress at business at 123 Main Street, Happy Sparrow, Calif., 91234—The workers are at the location at (321) 555-4321. This message will repeat total of four times. PLEASE TAKE A NOTE OF ADDRESS AND PHONE NUMBER.
      The voice message will become activated (broadcast) after the recipient (in this case the police) phone goes off-hook. The message will repeat four times within 3 minutes giving the police opportunity to make note of address and phone number(s). The text message, however, is sent only once. The ear piercing siren can only be deactivated at the system console.
b. After Hours: This “Commercial/Business—STAY—After Hours” mode is for when the business is closed at night or over weekend/holiday. This is typically used by the owner/manager or authorized representative to remove cash from the premises or conduct inventory control operations while locking themselves inside and activating this mode of operation. In this mode and to prevent false alarm to the police caused by operator mistake, the first phone number belonging to the business owner/manager is contacted. After a short pre-allotted time elapse the next three phone numbers (Authorized business associates and the trusted next door business owner/manager) are suppressed by the ARMED System. The local police will be contacted by the ARMED System if and when the System is not deactivated by the owner or the representative at the location who may have mistakenly upon an ARMED door. Deactivation can be done at the system console or remotely be the business owner/manager. Unless deactivated, the instantaneous ear piercing siren will continue until the police arrive. The siren can only be deactivated at the system console or by a separate remote command by the business owner/manager.
A typical 45 seconds voice message or text message for this mode “Commercial/Business—STAY—After Hours” of operation is;
   EMERGENCY: Intrusion, Vandalism, Rubbery, or Crime in progress at business at 123 Main Street, Happy Sparrow, Calif., 91234—Mr. or Mrs. Business Owner (name) is at the location. This message will repeat total of four times. PLEASE TAKE A NOTE AND CALL HAPPY SPARROW POLICE AT (321) 555-2121
      The voice message will become activated (broadcast) after the recipient phone (police) goes off-hook. The message will repeat four times within 3 minutes giving the police opportunity to make note of address and phone number(s). The text message, however, is sent only once. The business owner/manager may callback the ARMED System to stop the ear piercing siren.
c. Holdup Mode: The “Commercial/Business—STAY—Holdup” mode is activated when a wireless holdup push button(s) is (are) pressed. Theses buttons are located in the most convenient location to the business operators but inconspicuous locations from criminals' view where the imminent and approaching holdup can be spotted. Pressing the wireless Holdup Push Button(s) will bypass all programmed sequences of calls and will instantaneously activate the call to the local police station sending the voice message and text message.
NOTE: Only in this mode of operation, the siren will not be activated as to not aggravate the armed rubbers intent.
A typical 45 seconds voice message or text message for the this “Commercial/Business—STAY—Holdup” mode of operation is;
   EMERGENCY: ARMED RUBBERY AND HOLDUP in progress at 123 Main Street, Happy Sparrow, Calif., 91234—The workers are at the location at (321) 555-4321. POLICE ASSISTANT IS NEEDED AT ONCE. This message will repeat total of four times. PLEASE TAKE A NOTE OF ADDRESS AND PHONE NUMBER.
      The voice message will become activated (broadcast) after the police phone goes off-hook. The message will repeat four times within 3 minutes giving the police the opportunity to make note of address and phone number. The text message, however, is sent only once.

What is claimed is:

1) A protection/security alarm system that deters intruders and warns property owners, renters, or lessees using voice and/or text message via a conventional Landline utilizing current phone line infrastructure. The ARMED System's Fire Alarm uses an always “ON” combined Smoke and Heat Detector to eliminate false fire alarm.
This claim is against a configuration of the current invention entitled above and referred to as ARMED System consisting of eight major components. Under this claim the technology used between the Command Control Console (CCC) and recipients of outbound calls and inbound calls coming from remote access callers are based on the conventional Landline phone infrastructure.
These are namely;
1) Command Control Console (CCC) including the central processing unit (CPU), conventional or cellular phone engine, application software, Electrically-Erasable-Programmable-Read-Only-Memory (EEPROM) chips, and Memory Chips/Banks,
2) Wireless Motion Detectors,
3) Wireless Doorjamb Radio Frequency Magnet Sensors,
4) Electrically powered, wirelessly commanded siren system,
5) Wireless Panic/Holdup push button,
6) Exterior Mount bright red LED light indicating the activation/deactivation of ARMED System,
7) Remote Wireless Keypad to activate and/or deactivate the ARMED System from outside, and
8) A combined wireless Smoke and Heat Detector for No False warning of Fire.
The ARMED System subject of this claim and this invention eradicates the need for any TPI as it is programmed to notify owners, their trusted friends, family, and/or business associates and the most importantly local fire and police departments. As the TPI's are eliminated, the system becomes by far more responsive and quick in executing the security commands, less error prone as the chain of TPI worker interventions are eliminated, removes any and all time thresholds before activating the siren as the first line of crime deterrence, provides secured and authenticated remote access for ARMED System status check and activation/deactivation by authorized users, provides an audit trail with time stamps of who and when an entry to the premises or lockup of the premises was performed, all at the fraction of the cost to the end users who may currently be bind by long term contracts to receive much lesser of a service. The current invention is also the only complete end-to-end solution that can be available to the end users via retail outlets. The installation and programming are both easy and user friendly as opposed to purchasing existing alarm equipments only through the Third Party Intermediary companies at premium price and paying for installation and subscribing and paying for monthly monitoring service.
The CCC of the ARMED System is equipped with a mini alphanumeric keyboard and a menu driven programmable software. All menu options can be selected directly on the keyboard to set alerts and escalations. The phone numbers, addresses, and text messages can all be entered from this user friendly menu driven console. The System's CCC means of communication with all components of the ARMED System is wireless and as such provides for ease of installation, programming, and operation. The wireless RF (Radio Frequency) motion detector(s) and the wireless magnetic doorjamb sensors as well as the siren are equipped with a bright red LED indicating the activation/deactivation status of the ARMED System. The wireless and childproof panic push button(s) once pressed will cause CCC to instantaneously activate the siren and place a call to the local police department with pre-programmed message. The bright red LED mounted outside in a conspicuous location informs the approaching occupants that the ARMED System is activated and eliminates the possibility of False Alarm. It also warns the criminals as to the ARMED state of the property. The wireless exterior keypad provides an alternate method for activating/deactivating above and beyond doing so at the console or remotely via calling in to the system. A combined Smoke and Temperature sensor enables the always “ON” Fire alarm to send a instantaneous S.O.S Voice Message and Text Message to the local fire department while eliminating the chance of sending a false alarm due to excessive smoke from cooking or from starting the wood-burning fireplace.

2) A protection/security alarm system that deters intruders and warns property owners, renters, or lessees using voice and/or text message via a Voice over Internet Protocol (VoIP) with use of phone company data-line and DSL modem or Cable Company's Cable/DSL Modem. The ARMED System's Fire Alarm uses an always “ON” combined Smoke and Heat Detector to eliminate false fire alarm.
Under this the second claim and configuration of the current invention the technology and communication protocol used between the ARMED System's CCC and recipients of outbound calls and inbound calls coming from remote access callers ride on Digital Subscriber Line (DSL) Infrastructure of phone companies or on data line provided by Cable Operators.
The ARMED System based on the infrastructure of the end user choice will use a Telephone Service Data-Line with their DSL Modem or Cable Operators' Cable Modem to access the Voice over Internet Protocol. In either cases the conceptual design and configuration of this the second claim will remain the same as the first claim and the CCC utilizes a conventional phone engine to call out or receive calls. All amenities as provided in the first claim will also be provided under this claim including the outbound text messaging.

3) A protection/security alarm system that deters intruders and warns property owners, renters, or lessees using voice and/or text message via a Cellular Phone Network Infrastructure. The ARMED System's Fire Alarm uses an always “ON” combined Smoke and Heat Detector to eliminate false fire alarm.
Under this the third claim and configuration of the current ARMED System invention the technology and communication protocol used between the ARMED System's CCC and recipients of outbound calls and inbound calls coming from authorized remote access callers ride on wireless cellular Infrastructure of wireless communication companies. The ARMED System's CCC utilizes a cellular phone engine to call out to send voice and text message or receive secured and password authenticated remote calls over the cellular phone system of the end user choice. Also in this the third claim the conceptual design and configuration of ARMED System remains similar to that of the first two claims in providing all amenities numerated therewith including the outbound text messaging.
